(19) United States
(12) Patent Application Publication
(10) Pub. No.: US 2026/0258230 A1
(43) Pub. Date: Sep. 3, 2026

(54) METHOD FOR PREPARING A NEW WATER-SOLUBLE AND BIODEGRADABLE MATERIAL

(71) Applicants: ALONSO JUAN CARLOS ABAUNZA, San Gallen (CH); ECOITALY SOCIETÀ A RESPONSABILITÀ LIMITATA, Cinisi PA (IT)

(72) Inventor: Amador Gumersindo ABAUNZA, Orizaba, Veracruz (MX)

(73) Assignees: ALONSO JUAN CARLOS ABAUNZA, San Gallen (CH); ECOITALY SOCIETÀ A RESPONSABILITÀ LIMITATA, Cinisi PA (IT)

(21) Appl. No.: 18/846,750

(22) PCT Filed: Mar. 14, 2023
(86) PCT No.: PCT/IB2023/052445

§ 371 Date: Sep. 13, 2024

(30) Foreign Application Priority Data
Mar. 15, 2022 (IT) 102022000005000

(51) Int. Cl. C08L 3/02; B65D 65/46; B65F 1/00; C08J 3/215; C08J 5/18; C08K 3/16; C08K 3/38; C08K 5/053; C08K 5/098; C08K 11/00; C08K 13/08

(52) U.S. Cl. CPC C08L 3/02; B65D 65/466; B65F 1/0006; C08J 3/215; C08J 5/18; C08K 13/08; B65F 2240/136; C08J 2303/02; C08J 2401/26; C08J 2429/04; C08K 3/16; C08K 2003/387; C08K 5/053; C08K 5/098; C08K 11/00; C08K 2201/014; C08L 2201/06; C08L 2205/03

(57) ABSTRACT

A new water-soluble and biodegradable material is provided, useful for replacing products made of plastic, and the related preparation method. In particular, a method for preparing a new water-soluble and biodegradable material based on water, polyvinyl alcohol, cellulose-derived polymers and corn starch, useful for preparing products such as bags for transport, bags for garbage and food packaging, and a material obtainable by such method is provided.

### FIELD OF THE INVENTION

The present invention relates to a new water-soluble and biodegradable material, useful for replacing products made of plastic, and the related preparation method. In particular, the present invention relates to a method for preparing a new water-soluble and biodegradable material based on water, polyvinyl alcohol, cellulose-derived polymers and corn starch, useful for preparing products such as bags for transport, bags for garbage and food packaging, and a material obtainable by such method.

### STATE OF ART

The problem of undifferentiated or abandoned plastic on the planet every year destroys thousands of marine specimens and causes a considerable environmental impact.

A not biodegradable plastic bag takes 10 to 30 years to dissolve completely and it releases a series of substances which produce pollution the catastrophic part thereof we all know.

The term “biodegradable” was used in approximate manner in the first phases. The initial standards formulated to determine biodegradation actually are equivalent only to physical degradation, based upon the loss in tensile strength, discoloration and fragmentation. Many products claim biodegradability based upon theses obsolete standards, which were not declared obsolete against standards like ISO 14855 and ASTM D 5338. Some materials, which limit to disassemble or disintegrate in smaller pieces over time were declared to be “biodegradable” even if actually they are not biodegradable in the strict meaning of the term.

A usual bag made of biodegradable plastic takes at least six months to decompose by 90% and, however, the problem is the portion surviving in the environment for years by causing pollution, a type of pollution which in recent years has made ocean portions to be wholly invaded by plastic, causing indignation of all world population.

Over the last years many patent applications in the field of biodegradable materials have been filed. The prior art mainly failed in one or more of these four areas: 1) the items did not have a sufficient resistance, 2) the items had a poor shelf life, 3) the items were too expensive and/or 4) the workability of a useful item was difficult and expensive. The area in which failure occurred more often was the price, since some of the products manufactured with such biodegradable polymers cost up to 5-20 times more than the not biodegradable products available on the market. Another defect of these products is that they are photodegradable, thus by influencing the tensile strength of the product.

The polymers based on starch and other products disintegrate by simply breaking into small particles not visible to the naked eye after burying with consequent biomass which may have toxic properties. They are also weak and too fragile by nature and they must be planned to obtain the virgin plastic properties. Another defect of the starch-based products is that they lose force under typical preservation conditions through absorption of humidity, leading to a plastic weakening. There were many attempts at implementing items degradable by the environment by using polymers. However, due to the prohibitive costs, difficulty in processing and lack of sufficient shelf life in the applications for final use, they found a limited commercial success. Many compositions which have an excellent degradability have only a limited processability. On the contrary, the compositions which can be processed more easily have a reduced biodegradability.

### DETAILED DESCRIPTION OF FIGURES

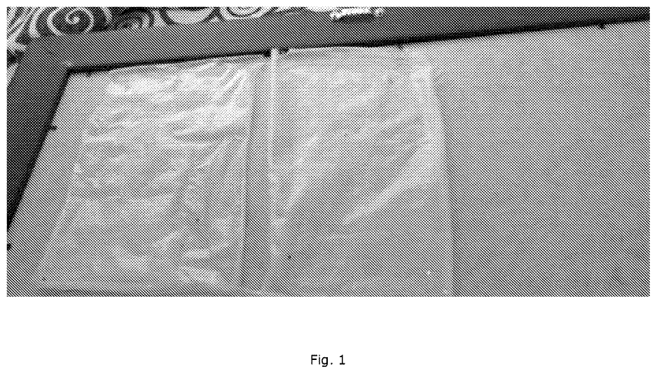

FIG. 1 Water-soluble and biodegradable material obtained by the method described in the invention.

### SUMMARY OF THE INVENTION

The technical problem placed by the present invention is to provide a water-soluble and biodegradable material, with properties so as to be able to replace products made of plastic, in order to give solutions to the problems of hydrogeological contamination.

The solution provided by the present invention consists in a method for preparing a water-soluble and biodegradable material, and a product obtainable by such method. The advantages deriving from using the product obtained by the method claimed in the present invention are several.

First of all, the product water-solubility will allow anyone using it to remove completely the biodegradability problem in favour to an immediate water-solubility, not dangerous for the environment.

Moreover, considering the presence of polyvinyl alcohol, a hydrolysed monomer based on modified copolymer and a vinyl acetate, allows the product to result to be compatible with a great number of machines which already produce plastic bags, then by making remarkably easy to implement such material due to the already known technologies.

Another advantage derives from the complete absence of ingredients derived from oil, thus by making the advantage for the environment a peculiar feature of the product.

From a practical point of view, for the water-solubility of the material one selected not to make it water-soluble in cold water (temperature lower than 40° C.), since upon laying on the ground a bag made of the material, the invention relates to, on rainy days, the same would start its dissolving process, thus by causing the bag rupture, reason why apart from being unpractical, it also would also result to be hardly saleable from an economic point of view. In particular, as water-solubility temperature that of 60° C. was selected, corresponding to the temperature used in an average washing cycle of Italian washing machines, so that the water-solubilization process can be performed by putting the used bags inside the washing machine together with the other clothes to be washed, without causing any problem at healthy level since the claimed method does not use any element harmful to health for the material production.

Moreover, from an economic point of view, the preparation method was developed so as to be within cost parameters affordable for those who should have to deal with manufacturing and distribution of the products of the material obtained by such method.

Therefore, the objects of the present invention are:

A method for preparing a water-soluble and biodegradable material, comprising the following steps:
i) mixing water, polyvinyl alcohol, cellulose-derived polymers, corn starch and optionally one or more additives at a temperature from 60 to 80° C., in order to obtain a sheet having a thickness between 150 and 300 microns, preferably between 180 and 220 microns, still more preferably 210 microns;
ii) Forming of the material prepared at step i);
iii) Drying the material formed at step ii) for at least 2 days, preferably in an environment not exposed to the sun.

A water-soluble and biodegradable material obtainable by the method according to any one of the herein described embodiments.

Additional advantages and/or embodiments of the present invention will be evident from the following detailed description.

### DETAILED DESCRIPTION

The first object of the present invention is a method for preparing a water-soluble and biodegradable material, comprising the following steps:
i) mixing water, polyvinyl alcohol, cellulose-derived polymers, corn starch and optionally one or more additives at a temperature from 60 to 80° C., in order to obtain a sheet having a thickness between 150 and 300 microns, preferably between 180 and 220 microns, still more preferably 210 microns;
ii) forming of the material prepared at step i);
iii) drying the material formed at step ii) for at least 2 days, preferably in an environment not exposed to the sun.

In an embodiment of the invention, said water is present in a concentration from 76% to 89% w/w, preferably 84.14% w/w; said polyvinyl alcohol is present in a concentration from 2.5% to 5.98% w/w, preferably 4.26% w/w; said cellulose-derived polymers are present in a concentration from 0.31% w/w to 0.67% w/w, preferably 0.51% w/w; said corn starch is present in a concentration from 2.85% w/w to 6.45% w/w, preferably 5.11% w/w; said additives are present in a total concentration from 3.85% w/w to 7.25% w/w, preferably 5.98% w/w.

In a preferred embodiment, said polyvinyl alcohol is a polyvinyl alcohol with a molar hydrolysis percentage higher than 99%, preferably higher than 99.3%, still more preferably 100%.

The polyvinyl alcohol with the above-mentioned features is represented by the product having CAS number 9002-89-5.

In an embodiment, cellulose-derived polymer is carboxymethyl cellulose (CMC).

The carboxymethylcellulose, or CMC, is a polymer derived from cellulose wherein some hydroxyl groups (—OH) are replaced by carboxymethyls (—CH₂—COOH). It is a food additive identified by the code E466, used in particular as thickener and even in the paper industry for the production of food packaging papers. Under code E466 even the sodium salt of the polymer is designated, that is sodium carboxymethylcellulose, a compound obtained by treating the cellulose at first with alkali and then with sodium monochloroacetate; it has the aspect of fibrous or granular powder, with colour from cream white to white; soluble in both cold and hot water. It is stable in a pH range from 5 to 10 and it has a good compatibility against alcohol: in the low concentration dispersions, up to 40 per cent thereof can be added. It has stabilizing properties and properties of protective colloid.

In a preferred embodiment, said additives include: magnesium stearate, soy vinegar, propylene glycol, cetyl alcohol, potassium sorbate (E202), sodium chloride, white vinegar, glycerol, sodium tetraborate and any combination thereof.

In an additional embodiment, said magnesium stearate is present in a concentration from 0.13% w/w to 0.67% w/w, preferably 0.51% w/w; said soy vinegar is present in a concentration from 0.22% w/w to 0.68% w/w, preferably 0.46% w/w: said propylene glycol is present in a concentration from 0.64% w/w to 1.20% w/w, preferably 0.89% w/w; said cetyl alcohol is present in a concentration from 0.22% w/w to 0.69% w/w, preferably 0.43% w/w; said potassium sorbate is present in a concentration from 1.0% w/w to 1.9% w/w, preferably 0.43% w/w; said sodium chloride is present in a concentration from 1.0% w/w to 1.9% w/w, preferably 0.39% w/w; said white vinegar is present in a concentration from 1.0% w/w to 1.9% w/w, preferably 1.3% w/w; said glycerol is present in a concentration from 1.0% w/w to 2.240% w/w, preferably 1.53% w/w; said sodium tetraborate is present in a concentration from 0.017% w/w to 0.069% w/w, preferably 0.04% w/w.

In a particularly preferred embodiment, step i) of the method, the present invention relates to, further comprises the following steps:
a) mixing water and polyvinyl alcohol until the polyvinyl alcohol is completely dissolved, for at least 20 minutes at a temperature comprised between 60 and 70° C.;
b) addition of carboxymethyl cellulose;
c) addition of a mixture of magnesium stearate and soy vinegar;
d) addition of propylene glycol;
e) adding cetyl alcohol and maintaining the mixture at a temperature below 70° C.;
f) addition of potassium sorbate (E202);
g) addition of a solution of water and sodium chloride:
   h) addition of white vinegar.
i) addition of glycerol
l) addition of a solution of corn starch and water;
m) addition of a solution of sodium tetraborate and water.

In an embodiment, according to any one of the herein described embodiments, said forming step ii) is performed by spreading on a stainless-steel sheet or by mechanical extrusion.

In an additional embodiment, the method of the present invention comprises an additional step for cleaning the oily part generated by cleaning means during the extrusion phase, preferably said cleaning means operating constantly, thus preventing the obtained film from breaking. Said cleaning means for example can consist or comprise one or more nozzles.

In a particularly preferred embodiment, the method, the invention relates to, comprises the following steps:
i) mixing 76.72% w/w of water and 4.26% w/w of polyvinyl alcohol until the polyvinyl alcohol is completely dissolved, for at least 20 minutes at a temperature from 60 to 70° C.;
ii) addition of 0.51% w/w of carboxymethyl cellulose;
iii) addition of a mixture of 0.51% w/w of magnesium stearate and 0.46% w/w of soy vinegar;
iv) addition of 0.89% w/w of propylene glycol;
v) adding 0.43% w/w of cetyl alcohol and maintaining the mixture at a temperature below 70° C.;
vi) addition of 0.43% w/w of potassium sorbate (E202);
vii) addition of a solution of 0.86% w/w of water and 0.39% of sodium chloride;
viii) addition of 1.30 % w/w of white vinegar.
ix) addition of 1.53% w/w of glycerol;
x) addition of a solution of 5.11% w/w of corn starch and 6.39% w/w of water;
xi) addition of a solution of 0.04% of sodium tetraborate and 0.17% of water;
xii) Forming;
xiii) Drying in an environment not exposed to the sun for at least 2 days.

An additional object of the present invention is a water-soluble and biodegradable material obtainable by the method described by any one of the herein described embodiments.

The material, the invention relates to, can be provided in form of bags for transport, bags for garbage, food packaging, bags for collecting animal faeces, bags for fertilizers and the like.

In any portion of the present description and of the claims, the term comprising can be replaced by the term “constituted by”.

Examples are reported hereinafter having the purpose of better illustrating the methods disclosed in the present description, such examples are in no way to be considered as a limitation of the preceding description and of the subsequent claims.

### EXAMPLES

During the several taken tests various types of sheets were obtained with specific resistance and thickness features (micron).

The selection of the sheets' features is determined even by the need for having available material which is compatible with the extrusion machines apt to implement bags in industrial quantities.

In order to evaluate the tensile strength of the products obtained by the method of the present invention, bags having a thickness of about 210 microns were produced and were filled-up with different objects (bottles, books, food packages), and they were compared with the common bags available in shops and supermarkets. It was demonstrated that the bags made of material obtainable by the present invention do not have any sign of rupture at least up to 8 kg of weight of items contained in the bag.

### Example 1 Material Preparation

1. Pre-arranging 9 litres of water and adding 500 grams of Selvol 165;
2. Stirring for 20 minutes and starting to heat the liquid until Selvol 165 is completely dissolved (around 65-70° C.);
3. Adding 60 grams of CMC Carboxymethyl cellulose;
4. Mixing separately 60 grams of Magnesium stearate with 54 grams of soya vinegar until the stearate is dissolved and then pouring the compound into the main container which is being heated. It is fundamental that the stearate is completely dissolved to avoid the formation of lumps;
5. Adding 100 mL of propylene glycol;
6. Adding 50 grams of cetyl alcohol. It is fundamental that the temperature of 70 degrees Celsius is not exceeded.
7. Adding 50 grams of potassium sorbate;
8. Preparing separately 46 grams of sodium chloride and diluting it in little water (50 MI cold water to be heated), and pouring the compound into the main container;
9. Adding 152 grams of white vinegar;
10. Adding 180 grams of glycerol;
11. Preparing separately 600 grams of corn starch con 750 ml of water, and pouring the compound into the main container;
12. Preparing separately 5 grams of Borax and diluting it in 20 ml of water, and pouring the compound into the main container. Subsequently, heating the compound in the main container until a maximum of 90 degrees (the compound can be heated not above 95° C.);
13. Turning off the heating source and leaving to cool down;
14. Forming on stainless-steel plate;
15. Drying in an environment not exposed to the sun for at least 2 days.

After 2 days a sheet will be obtained which will have the appearance of a plastic piece but which actually contains nothing plastic.

At this point it is possible to test the resistance thereof and afterwards to perform tests of dissolving in hot water. The material will dissolve completely and the obtained liquid, as demonstrated, can even be ingested with no damage for the organism.

1. A method for preparing a water-soluble and biodegradable material, comprising the following steps:
i) mixing water, polyvinyl alcohol, cellulose-derived polymers, corn starch and optionally one or more additives at a temperature from 60 to 80° C., in order to obtain a sheet having a thickness between 150 and 300 microns, preferably between 180 and 220 microns, still more preferably 210 microns;
ii) forming the material prepared at step i);
iii) drying the material formed at step ii) for at least 2 days, optionally in an environment not exposed to the sun.

2. The method according to claim 1, wherein
said water is present in a concentration from 76% w/w to 89% w/w, optionally 84.14% w/w; and/or
said polyvinyl alcohol is present in a concentration from 2.5% w/w to 5.98% w/w, optionally 4.26% w/w; and/or
said cellulose-derived polymers are present in a concentration from 0.31% w/w to 0.67% w/w, optionally 0.51% w/w; and/or
said corn starch is present in a concentration from 2.85% w/w to 6.45% w/w, optionally 5.11% w/w; and/or
said additives are present in a total concentration from 3.85% w/w to 7.25% w/w, optionally 5.98% w/w.

3. The method according to claim 1, wherein said polyvinyl alcohol is a polyvinyl alcohol with a molar hydrolysis percentage higher than 99.3%, optionally 100%.

4. The method according to claim 1, wherein cellulose-derived polymer is carboxymethyl cellulose (CMC).

5. The method according to claim 1, wherein said additives include: magnesium stearate, soy vinegar, propylene glycol, cetyl alcohol, potassium sorbate (E202), sodium chloride, white vinegar, glycerol, sodium tetraborate or any combination thereof.

6. The method according to claim 5, wherein:
said magnesium stearate is present in a concentration from 0.13% w/w to 0.67% w/w, optionally 0.51% w/w; and/or
said soy vinegar is present in a concentration from 0.22% w/w to 0.68% w/w, optionally 0.46% w/w; and/or
said propylene glycol is present in a concentration from 0.64% w/w to 1.20% w/w, optionally 0.89% w/w; and/or
said cetyl alcohol is present in a concentration from 0.22% w/w to 0.69% w/w, optionally 0.43% w/w; and/or
said potassium sorbate is present in a concentration from 0.21% w/w to 0.69% w/w, optionally 0.43% w/w; and/or
said sodium chloride is present in a concentration from 0.21% w/w to 0.69% w/w, optionally 0.39% w/w; and/or
said white vinegar is present in a concentration from 1.0% w/w to 1.9% w/w, optionally 1.3% w/w; and/or
said glycerol is present in a concentration from 1.0% w/w to 2.240% w/w, optionally 1.53%; and/or
said sodium tetraborate is present in a concentration from 0.017% w/w to 0.069% w/w, optionally 0.04%.

7. The method according to claim 1, wherein said step i) of mixing the ingredients consists of at least the following steps:
a) mixing of water and polyvinyl alcohol until the polyvinyl alcohol is completely dissolved, for at least 20 minutes at a temperature from 50 to 80° C.;
b) addition of carboxymethyl cellulose;
c) addition of a mixture of magnesium stearate and soy vinegar;
d) addition of propylene glycol;
e) adding cetyl alcohol and maintaining the mixture at a temperature below 60° C.;
f) addition of potassium sorbate (E202);
g) addition of a solution of water and sodium chloride:
h) addition of white vinegar.
i) addition of glycerol
l) addition of a solution of corn starch and water; and
m) addition of a solution of sodium tetraborate and water.

8. The method according to claim 1, wherein said forming step ii) is performed by spreading on a stainless-steel sheet or by mechanical extrusion.

9. The method according to claim 1, comprising the following steps:
i) mixing 76.72% w/w of water and 4.26% w/w of polyvinyl alcohol until the polyvinyl alcohol is completely dissolved, for at least 20 minutes at a temperature from 60 to 70° C.;
ii) addition of 0.51% w/w of carboxymethyl cellulose;
iii) addition of a mixture of 0.51% w/w of magnesium stearate and 0.46% w/w of soy vinegar;
iv) addition of 0.89% w/w of propylene glycol;
v) adding 0.43% w/w of cetyl alcohol and maintaining the mixture at a temperature below 70° C.;
vi) addition of 0.43% w/w of potassium sorbate (E202);
vii) addition of a solution of 0.86% w/w of water and 0.39% of sodium chloride;
viii) addition of 1.30 % w/w of white vinegar.
ix) addition of 1.53% w/w of glycerol;
x) addition of a solution of 5.11% w/w of corn starch and 6.39% w/w of water;
xi) addition of a solution of 0.04% of sodium tetraborate and 0.17% of water;
xii) Forming;
xiii) Drying in an environment not exposed to the sun for at least 2 days.

10. A water-soluble and biodegradable material obtainable by the method according to claim 1.

11. The material according to claim 10 in form of bags for transport, bags for garbage, food packaging, bags for collecting animal faeces, bags for fertilizers and the like.

12. (canceled)
